(19) United States
(12) Patent Application Publication
(10) Pub. No.: US 2011/0125400 A1
(43) Pub. Date: May 26, 2011

(54) Methods of Generating a Connectivity Chart for Elements of an Airport for Assistance in Taxiing and Associated Devices

(75) Inventors: Francois Michel, Saint Medard en Jalles (FR); Bernard Dubourg, Le Haillan (FR)

(73) Assignee: Thales, Neuilly Sur Seine (FR)

(21) Appl. No.: 12/671,009

(22) PCT Filed: Jul. 25, 2008
(86) PCT No.: PCT/EP2008/059836

§ 371 Date: Jun. 23, 2010

(30) Foreign Application Priority Data
Jul. 27, 2007 (FR) 07 05521

(51) Int. Cl. G08G 5/06; G01C 21/32

(52) U.S. Cl. 701/208

(57) ABSTRACT

The method of generating a connectivity chart for elements of an airport that makes use of:
data describing polygons, each polygon being referenced in a database of the aircraft, the data comprising at least one denomination, one type, one set of segments and one set of points, the polygons representing elements of an airport;
wherein the method generates, for any pair of polygons having a common boundary, at least one point, called node, situated on the boundary, the segment linking two consecutive nodes forming an axis with north.

### PRIORITY CLAIM

This application claims priority to PCT Patent Application Number PCT/EP2008/059836, entitled Methods of Generating a Connectivity Chart for Elements of an Airport for Assistance in Taxiing and Associated Devices, filed on Jul. 25, 2008.

### FIELD OF THE INVENTION

The field of the invention is that of assistance in the taxiing of an aircraft on an airport, handled notably by a representation of the trajectory to be followed by the aircraft on the airport and the display of information relating to the guidance and navigation of the aircraft.

### BACKGROUND OF THE INVENTION

Currently, in the context of airport phases, distribution of onboard/ground control responsibilities, the operational procedures, the traffic density and the large number of people involved on the airport platform are such that it is not possible for an aircraft to have equipment that has the capacity to synthesize all the information in order to move optimally.

One solution consists in using the existing systems installed on board the aircraft, such as the Flight Management System, or FMS, the Integrated Surveillance System, or ISS, and enriching them with taxiing assistance functions.

A flight management system conventionally comprises one or more microprocessors linked to a working memory, a program memory, a data storage memory and an input/output interface, these programs being designed to handle different functions. However, the functions that can be accessed via an FMS are insufficient to reach the objectives of the taxiing assistance function:

The locating proposed by an FMS system is of the order of 100 on whereas the ground part requires positioning means of the order of 10 m for the display functions, of the order of 1 m for the warning and guidance assistance functions and less than 1 no for the automatic guidance functions.

The construction of the “taxiing plan” is strongly imposed by the ground control authority, or Air Traffic Control (ATC), and is often incremental and partial according to the various control zones distributed over the airport. For example, on large international airports, like Paris Charles De Gaulle, a controller handles the runway zone, a second handles the taxiways and a third the passenger embarkation zones. The routing is then dictated to the pilot as he progresses. It stops at the limits of each control zone and cannot cover all of the movement, from the runway to the embarkation gate (or the reverse path). These problems lead to numerous vocal exchanges between the controller and the pilot during the taxiing phase which can be relatively lengthy on large airports. However, the tools and methods available in an FMS are not adequate because they are designed to describe all of a flight, from takeoff to landing, in order to perform all the calculations necessary to the consumption predictions and guidance instructions. Moreover, the descriptions of the procedures on the ground are not standardized, unlike the in-flight procedures which are available on board FMSs through a database deriving from data published by the state control organizations.

The PERF database of aircraft performance is not suited to the taxiing model.

The lateral trajectory computation module takes account of the performance of the aircraft whereas the taxiing on the ground has to take account of the topology of the airport.

The aim of the predictions is to construct an optimized vertical profile on the lateral trajectory. On the ground, only the horizontal speed can be adjusted.

The aim of the guidance on the ground is to present the instructions to be applied manually (apart from the emergency instructions).

Similarly, the functions that can be accessed via the ISS are inadequate for meeting the objectives of the taxiing assistance function:
the surveillance on the ground is not taken into account,
consolidation is not handled between traffic and terrain situations,
the anticipation functions are based on trajectories prepared from data from the FMS in 3D or 3D+time mode.

Moreover, some airport mapping systems, like those present in the EFBs, EFB being an acronym for Electronic Flight Bag (which are applications used by the pilots on laptop computers to prepare their flights and which are not part of the onboard avionics), or specific products such as the OANS, an acronym standing for On-Board Airport Navigation System, that make it possible to:
display the map of the airport showing the position of the aircraft and its situation relative to the topology of the airport and to the surrounding structures,
obtain information on “airport items” through the user interface,
obtain annotations, advice (e.g. “Approaching Runway”).

However, these functions provide only limited surveillance, because they are based exclusively on databases describing the geometry of the airport, whose update frequency is linked only to changes in the infrastructures and not to the usage rules dictated (and periodically modified) by the local control authorities; in particular, they are insufficient notably for:
displaying a map presenting the most varied airport information, such as, for example, the directions that are prohibited according to the landing direction chosen by traffic control according to the strength and direction of the local wind,
processing this same dynamic information to assist the crew in viewing or selecting the routing elements imposed by ground control,
providing a routing function offering the crew automation of the actions making it possible to sequence the designated routing elements and calculate various relevant parameters, such as an estimation of the fuel consumed, for example, or direction indications at the various branch tracks encountered and presenting the prepared routing to complement the map of the infrastructures.

Finally, some functions, like the “RAAS”, an acronym standing for Honeywell's Runway Awareness and Advisory System, available through the EGPWS product, have the role of warning the crew when approaching a runway. They are based on solely runway information, independently of the possible connections to taxiways or their actual activity. Furthermore, the segregation of the equipment used in the taxiing phases prevents these messages from being correlated with routing information prepared through a routing means or with a richer database having all the information concerning the airport area.

### SUMMARY OF THE INVENTION

The aim of the invention is to make it possible to provide effective taxiing assistance by having a connectivity of the various elements of an airport. These elements generally originate from an airport database that is onboard the aircraft. The connectivity of the elements is advantageously produced by the geometrical construction of navigation and guidance nodes of the airport. The latter can be represented on a map together with the trajectory to be followed by an aircraft when the routing instruction from air traffic control is known to the crew. The connectivity of the elements then makes it possible to anticipate a certain number of pilot actions in the taxiing phases. In this context, the invention proposes, according to the position of the aircraft in the airport, to display guidance and navigation information in an early fashion.

Advantageously, the method of generating a connectivity chart for elements of an airport that makes use of:
data describing polygons, each polygon being referenced in a database of the aircraft, the data comprising at least one denomination, one type, one set of segments and one set of points, the polygons representing elements of an airport;

and that generates:
for any pair of polygons having a common boundary, at least one point, called node, situated on the boundary, the segment linking two consecutive nodes forming an axis with north.

Advantageously, the method comprises:
the definition of a navigation arc, for each navigation node, the navigation arc being a segment linking two successive navigation nodes;
the determination of a heading, for each navigation node, called navigation heading, defining the angle between the direction of north and the navigation arc passing through the navigation node and oriented in the direction of passage of the aircraft;
the use of the position and the true heading of the aircraft supplied by the navigation system of said aircraft;
the use of the routing instructions originating from a ground-onboard communication device, the instructions comprising at least one destination and one route, the route comprising a series of elements of the airport navigation database management system, and;
the display of navigation airport information associated with a taxiing element from an onboard computer and viewing means, the navigation information being generated from the comparison of the true heading of the aircraft, the navigation heading and a position of a navigation node of an element of the instruction to be reached.

Advantageously, the method comprises the determination of a position of a node on a boundary, in such a way that the node is situated equidistant from each end of the boundary.

Advantageously, the methods comprises the display of a runway proximity indication, inasmuch as the aircraft is located on the single possible path leading to that runway.

Advantageously, the method uses data describing points of taxiing lines of an airport, the data originating from a database management system of the aircraft.

Advantageously, the method comprises the determination of at least one node, called guidance node, situated at the intersection of a boundary of two adjacent taxiing elements and a taxiing line.

Advantageously, the method comprises, for each guidance node, the definition of at least one guidance arc, the guidance arc being the shortest path to reach a next guidance node situated on a guidance line.

Advantageously, the method comprises, for each guidance node, the determination of a heading, called guidance heading, defining the angle between north and the segment linking points downstream and upstream of a guidance node situated on the taxiing line and oriented in the direction of passage of the aircraft.

Advantageously, the method uses a routing instruction originating from a ground-onboard communication device, the instruction comprising at least one destination and one route, the route comprising a series of elements of the airport navigation database management system.

Advantageously, the method comprises the determination of a guidance trajectory, from an onboard computer, by determining the series of the segments linking points of a taxiing line and guidance nodes situated on elements of the routing instruction.

Advantageously, the method comprises the determination of the guidance trajectories for which the value of the radius of curvature is between a predefined minimum value and a predefined maximum value.

Advantageously, the method comprises the determination of the guidance trajectories for which the angle formed by two segments of three successive points is between 2 pi/3 and 4 pi/3.

Advantageously, the method comprises the determination of the shortest trajectory satisfying a routing instruction.

Advantageously, the method comprises the generation of the plot of the guidance trajectory on a map of an airport from an onboard computer and viewing means.

Advantageously, the method comprises the generation of an indication of deviation from the trajectory when the true position of the aircraft deviates from the guidance trajectory.

Advantageously, the device for generating a connectivity chart for elements of an airport for aircraft intended for assistance in airport taxiing that implements the method of the invention, the device comprises:
a user interface, the user being the crew, this interface comprising a display device;
an airport navigation database management system comprising navigation and guidance information;
an onboard computer;
geolocating means;
a locating device linked to the geolocating means;
a mapping device comprising a map of an airport, the latter being linked to the locating device, to the database management system and to the display device;
a ground-onboard communication device, able to deliver routing instructions, the instructions comprising at least one destination and one route, the route comprising a series of elements of the airport navigation database management system.

Advantageously, the display device comprising a plot of the trajectory to be followed by the aircraft overlaid on the map of the airport and the current position of the aircraft.

Advantageously, the device comprises means for manually inputting instructions originating from air traffic control.

Advantageously, the device comprises means for automatically inputting instructions originating from air traffic control.

### BRIEF DESCRIPTION OF THE DRAWINGS

Other features and benefits of the invention will become apparent from the following description given in light of the appended drawings which represent:

FIG. 1: navigation nodes and navigation arcs;

FIG. 2: the definition of a navigation node on a boundary of two taxiing elements;

FIG. 3: a map of an airport comprising nodes and navigation arcs;

FIG. 4A: taxiing elements that are not relevant to the crew from other taxiing elements;

FIG. 4B: the elimination of certain taxiing elements from the navigation chart;

FIG. 5: navigation indications taken into account by the navigation chart;

FIG. 6: the map of an airport with the representation of the aircraft;

FIG. 7: guidance nodes and guidance arcs;

FIG. 8: a case of a taxiing element passed through by two taxiing lines;
case of a turn and of the associated taxiing elements in the preparation of the trajectory to be followed for an aircraft.

### DETAILED DESCRIPTION OF REFERRED EMBODIMENT

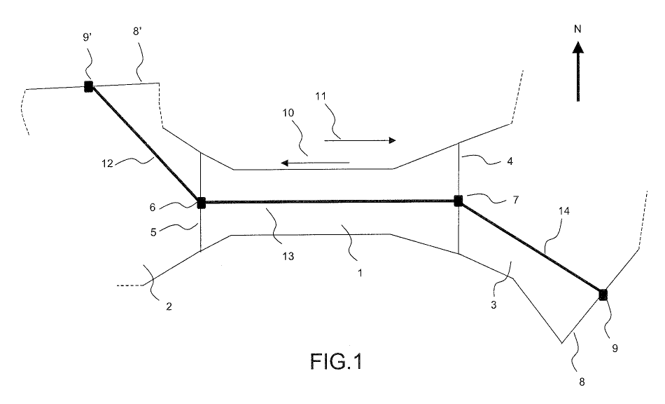

FIG. 1 represents elements of an airport formed by polygons 1, 2 and 3. These elements are called “taxiing elements” hereinafter in the description. Each of the polygons is described in the airport database by segments and points georeferenced relative to a known origin of the airport.

These taxiing elements can be of various types, for example “taxiways”, “parking” areas, “runways”, or even “road service elements”, according to the English teiminology used in aeronautics. These taxiing elements generally describe parking zones, taxiing zones, taxiing zone intersections, portions of a runway or even zones intended for the entry and exit of service vehicles.

There is currently no database or function that links the various taxiing elements together. The taxiing elements are represented “flat” so as to be able to construct maps that faithfully reflect the reality of the topology of the airport.

The inventive method proposes creating a connectivity chart, hereinafter called navigation chart, between the various taxiing elements. The data describing the connectivity of the taxiing elements of the airport are then stored in a database of the aircraft. This database is generally updated in the aircraft in ground maintenance phases or before leaving for a new takeoff. In order to describe the connectivity of the various taxiing elements, the inventive method proposes defining navigation nodes.

The navigation nodes are constructed geometrically on each boundary separating two taxiing elements. In one embodiment case described in the present description, the position of the navigation node on the boundary can be, for example, situated in the middle of the boundary, the latter being able to comprise one or more segments.

In the drawing of FIG. 1, the navigation nodes 9′, 6, 7 and 9 joining the taxiing elements 2, 1 and 3 are respectively positioned in the middle of the boundaries 8′, 5, 4 and 8. The navigation nodes are linked by segments 12, 13 and 14, each of which forms a navigation heading with north N dependent on the direction toward which the aircraft is directed.

The aircraft in this example can taxi from the taxiing element 2 to the taxiing element 3 by passing through the taxiing element 1 in a direction 11, or can taxi in the reverse direction from the taxiing element 3 to the taxiing element 2 by passing through the taxiing element 1 in the reverse direction 10.

Hereinafter in the description, the term “navigation arc” will be used to mean the segment joining two successive navigation nodes.

The set of navigation nodes defines a navigation chart.

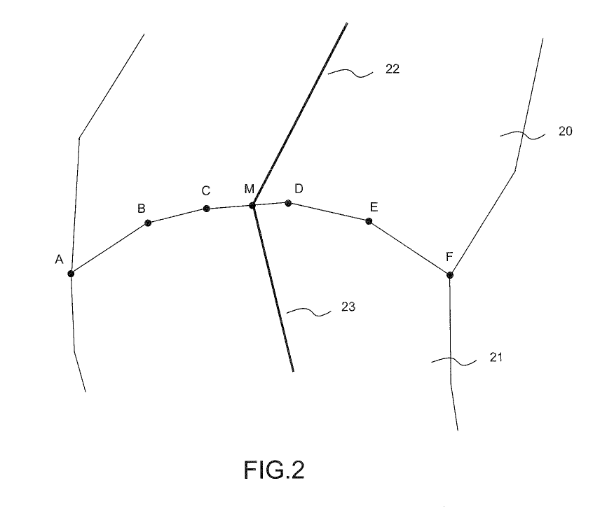

FIG. 2 illustrates an exemplary boundary between two taxiing elements 20 and 21, each representing airport zones. The boundary comprises five segments of which the positions of the ends A, B, C, D, E and F are defined in the aircraft's airport database. The inventive method makes it possible to define the middle M of the boundary that is equidistant from the points A and F. The node M is joined to the downstream node and to the upstream node by the segments 22 and 23.

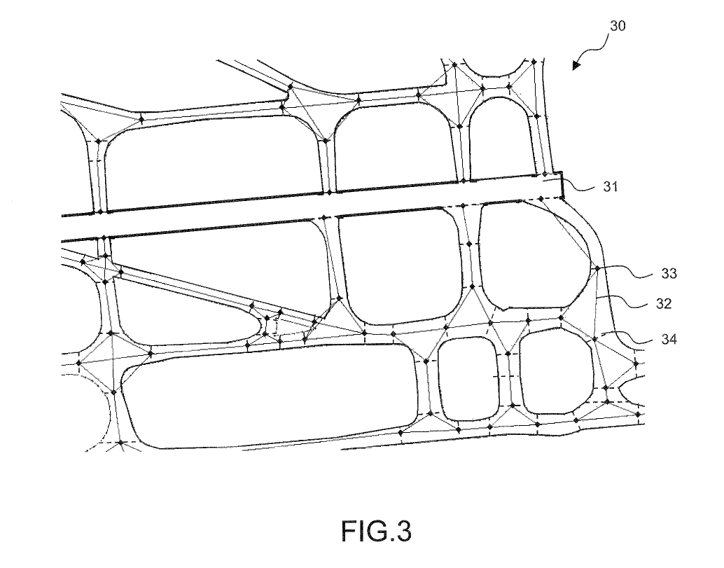

FIG. 3 illustrates a plan 30 of an airport comprising a runway 31 and taxiing elements such as approach or exit lanes for the runway 31 and junction elements for multiple lanes. The navigation nodes are situated in the middle of each boundary of each element. The segments joining the various nodes are represented therein, such as the nodes 33 and 34 whose connection is represented by a segment 32.

Each of the nodes has two directions of passage associated with it, and a direction of passage is made up of three items:
a departure element (one of the two connected taxiing elements);
an arrival element (the other connected element);
a navigation heading which defines the direction taken for a direction of passage of the aircraft. Formally, this navigation heading is the angle formed between a navigation arc and north (in the trigonometrical sense).

In the example of FIG. 1, the navigation heading formed by the navigation arc linking the node 7 to the node 9 to pass from the taxiing element 1 to the taxiing element 3 is 270° with north. The reverse direction, from the node 9 to the node 7, is the heading 70°.

The inventive method makes it possible to dispense with certain types of elements of an airport that are not necessary to the crew in the navigation chart. For example, the elements called “service road element” are not necessary to aircraft navigation assistance, these elements being intended for service vehicles. At no time are these elements cited in a taxiing instruction by air traffic control to indicate a route to the crew. Thus, the inventive method makes it possible to define a connectivity between taxiing elements, the latter being consistent with an instruction originating from air traffic control.

For this, the inventive method, firstly, makes it possible to identify the points and the segments relating to a geometrical element of a specific type such as that defined previously, of polygonal form. Secondly, the inventive method makes it possible to merge the two boundaries either side of the taxiing element upstream and downstream.

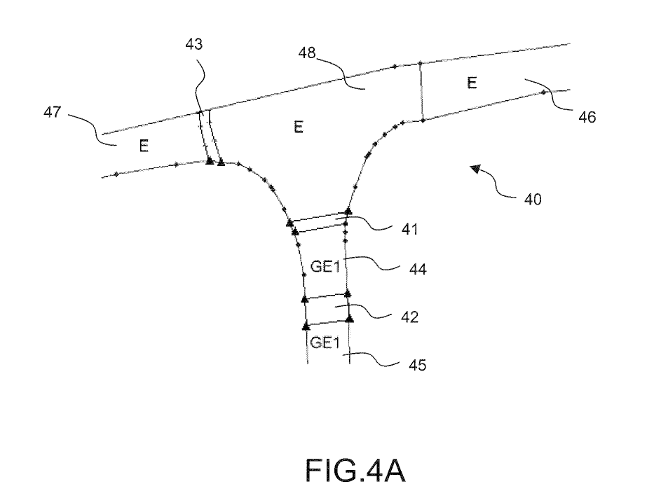

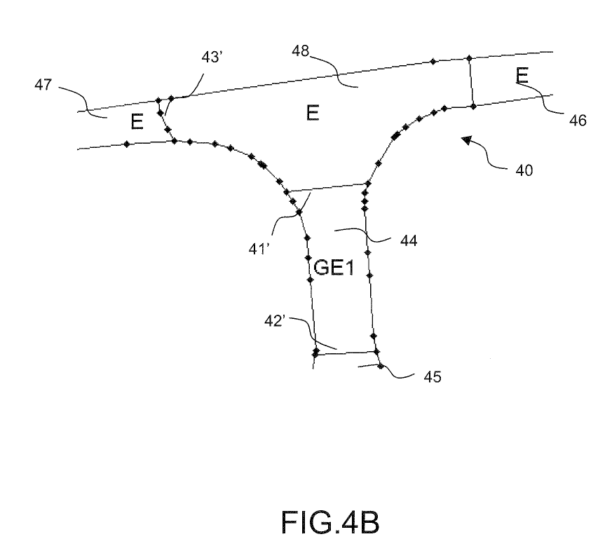

FIG. 4A represents a portion of an airport comprising different taxiing elements 45, 42, 44, 41, 48, 46, 43 and 47 of different types. Among these elements, some are intended for service vehicles, notably the elements 42, 41 and 43. They are therefore not necessary to aircraft navigation assistance. The method makes it possible to merge each of the boundaries of the elements 42, 41 and 43 into a single boundary separating the elements 45 and 44 on the one hand and the elements 44 and 48 on the other hand, and finally the elements 47 and 48.

The inventive method therefore makes it possible to consider the type of an element and its geometrical description.

FIG. 4B represents, after the merging of the boundaries of the elements that are not necessary to the crew, the regenerated airport map.

The new boundaries 43′, 41′ and 42′ are boundaries separating taxiing elements on which navigation nodes are automatically generated.

The inventive method makes it possible to define a navigation arc concept between different nodes. The navigation arcs have no geometrical representations but make it possible on the one hand to link the nodes together in the database and on the other hand to define a mean heading between two nodes, called navigation heading.

In a taxiing phase, the construction of the navigation chart comprises a first step of the inventive method to make use, in a second step, notably, of one or more routing instructions originating from air traffic control.

An instruction sent by air traffic control to the crew can be, for example: TAXI TO “STAND 8” VIA “A-T50-T20-N4”. The latter instruction is translated by “go to the parking zone called “STAND 8” using the route passing through the various elements named: A, T50, T20, N4.

The manual input of the instruction by the crew into a user interface in the cockpit or the automatic acquisition of the instruction by an onboard computer makes it possible to link the taxiing elements of the instruction through knowledge of the connections in the airport navigation chart. Each navigation chart is created previously, before the input of an instruction. The navigation nodes are situated on each of the boundaries, the elements that are not necessary to navigation having been eliminated from the map by the method.

Following the receipt of this instruction, the aircraft must pass through the corresponding nodes at each boundary of the elements cited in the instruction. By observing the order of the elements in the instruction, the various nodes of the elements cited in the instruction through which the aircraft must pass in succession can be noted, for example, N1, N2, N3, N4 and N5. In the database, the node N1 is connected to the node N2, which is in turn connected to the node N3, which is in turn connected to the node N4, which is in turn connected to the node N5.

The navigation chart makes it possible to generate the information similar to that found on the indicator panels of an airport.

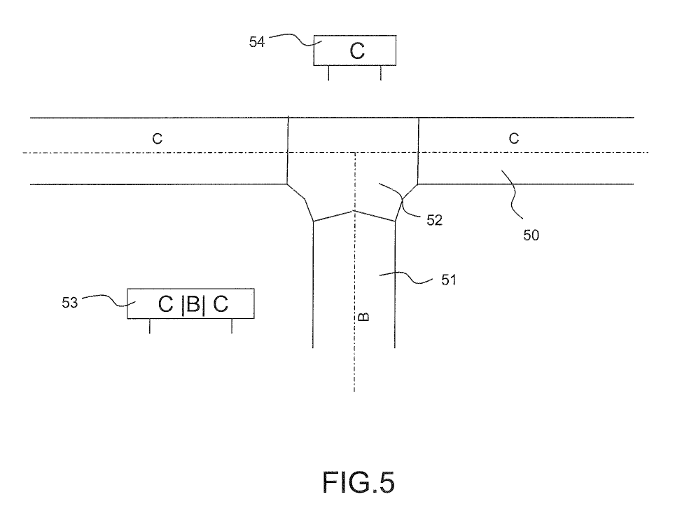

FIG. 5 illustrates the type of navigation information 53 and 54 giving the names of certain lanes and of certain directions associated with the lanes, the latter being represented by an arrow symbol. The taxiing elements 50, 51 and 52 are represented.

Moreover, the method uses existing means making it possible to supply useful positioning information regarding the situation of the aircraft. This information is generally generated by the onboard computers from information received via external signals or supplied by integrated sensors. Among other things, this information includes position information and information on the true heading followed by the aircraft. Each time the aircraft passes close to a navigation node, the method makes it possible, by analyzing the position of the aircraft and of the closest navigation point, to supply and display navigation information on viewing means. This navigation information comprises, for example, the traffic lane to which the airplane is directed or safety information.

Since the nodes are connected, it is possible to display navigation information early concerning the next taxiing elements such as the other traffic lanes in the vicinity by comparing the true heading of the aircraft with the navigation heading of the navigation arcs. The method makes it possible to compare the true heading of the aircraft with the passage of the navigation node and of the next node to be reached, and therefore the navigation heading.

The inventive method makes it possible, for example, to generate a particular indication if the aircraft is moving on a lane leading to a runway, the only possible path in the navigation chart leading to a runway.

Using the information on the connectivity of the airport taxiways, the inventive method provides for greater anticipation in relation to the information relating to the proximity of a runway.

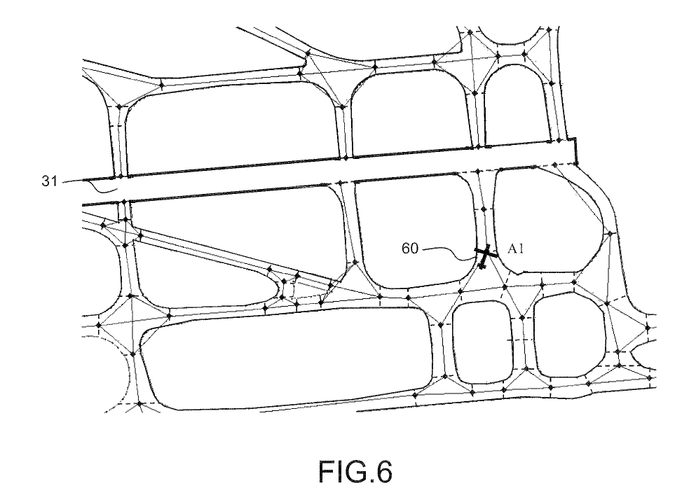

For example, in FIG. 6, immediately upon passing over the navigation node μl, the method makes it possible to signal to the pilot of the aircraft 60 that this lane is leading it to a runway 31.

The inventive method also makes it possible to establish a second connectivity chart. Since the connectivity is established in relation to guidance elements, the latter chart is hereinafter called guidance chart.

This step also makes it possible, as for the navigation chart, in a second step to use a routing instruction for navigation assistance in the airport.

The guidance elements are then points of a taxiing line. The taxiing lines are generally plotted on the taxiing elements of an airport and are often represented by a yellow mark. These lines are generally defined in the airport database by certain points of the taxiing line that are georeferenced. These lines can possibly be discontinuous depending on the type of taxiing elements.

The guidance chart is made up of:
a set of guidance nodes;
a set of guidance arcs, a guidance arc linking two successive guidance nodes.

A guidance node corresponds to an intersection between a taxiing line and the boundary between two taxiing elements.

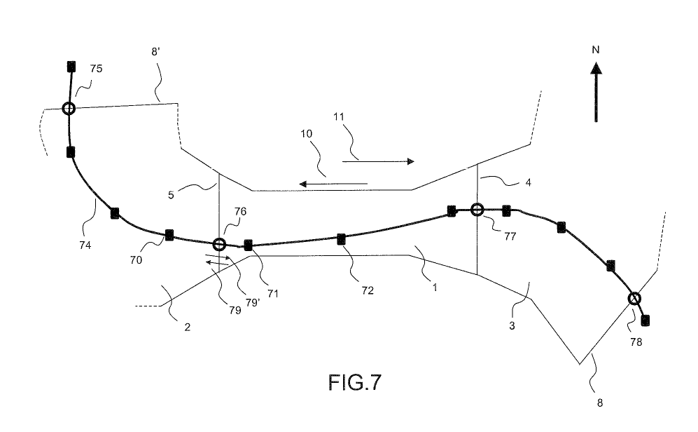

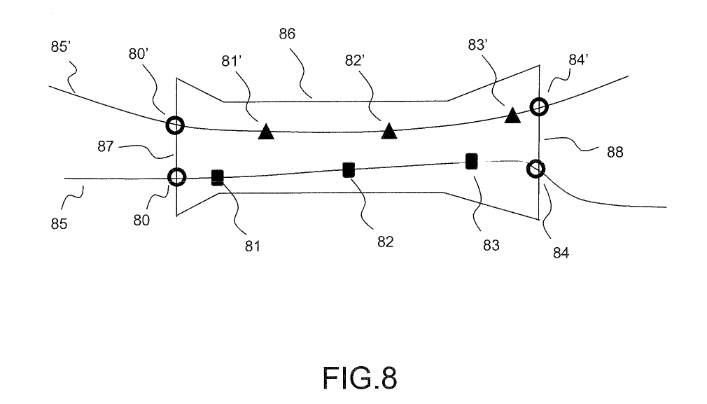

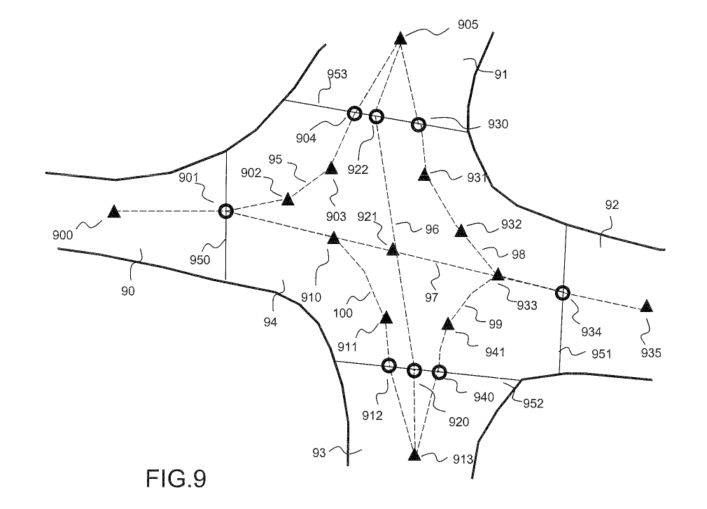

FIG. 7 represents taxiing elements 1, 2, 3 separated by boundaries 4 and 5. The coordinates of certain points of a taxiing line 74 are defined in the airport database. On the other hand, currently, no connectivity is produced to link a taxiing line to the taxiing elements of an airport.

The inventive method makes it possible to define guidance nodes 75, 76, 77, 78. The points of a taxiing line that are upstream and downstream of a boundary separating two taxiing elements form a segment that intercepts a boundary (8′, 5, 4, 8) at a point, and this point is a guidance node.

As for the navigation chart, each node has two directions of passage associated with it, for example the node 76 has two directions of passage 79, 79′ represented in FIG. 7. A direction of passage is made up of three items:
a departure element (one of the two taxiing elements)
an arrival element (the other connected element)
a guidance heading which defines the direction taken for this direction of passage.

Formally, this guidance heading is the angle formed between the segment linking the two points upstream and downstream of an intersection of a taxiing line with a boundary of two taxiing elements and north.

FIG. 8 represents a taxiing element 86 on which are plotted two taxiing lines 85, 85′ which intercept the boundaries 87 and 88 at four guidance nodes 80, 80′, 84, 84′.

The taxiing lines are identified in the airport database by a first set of points 81, 82, 83 concerning the first taxiing line 85 and a second set of points 81′, 82′, 83′ for the second taxiing line 85′.

The guidance lines supporting the guidance arcs must satisfy the following two criteria:
the curve formed by a set of consecutive segments of a guidance line must have a radius of curvature that is compatible with the performance of the aircraft, the segments being determined between each pair of successive points and between each point and each node following each other on the guidance line;
they are optimal: if there are several guidance lines meeting the first criterion that link two nodes, then the inventive method selects the shortest distance arc.

The first criterion can be expressed by a constraint on the minimum and maximum radius of curvature of the plot of the guidance line followed by the aircraft.

In an exemplary case, it can be considered that two consecutive segments in a guidance line must have an angle of between 2 π/3 and 4λ/3.

FIG. 9 represents the case of a taxiing element 94 situated at the intersection of four other taxiing elements 90, 91, 92, 93. Taxiing lines 95, 96, 97, 98, 99, 100 are plotted on the ground, each of the routes comprising points 900, 902, 903, 905, 910, 911, 913, 921, 931, 932, 933, 941, 935 defined in the airport database.

The intersections between the taxiing lines and the boundaries 950, 951, 952, 953 between the various taxiing elements define, as defined previously, guidance nodes 901, 904, 922, 930, 912, 920, 940, 934.

When an aircraft arrives at the point 900 of the taxiing element 90 and it wants to go to the point 913 of the taxiing element 93, the inventive method makes it possible to display a path linking, in succession, the point 900, the node 901, the points 910 and 911, the node 912 and the point 913. This path satisfies the condition defined previously expressing that the angle formed between two successive arcs of the taxiing line displayed is between 2 π/3 and 4 π/3. Moreover, if a number of taxiing lines meet this condition, the second criterion ensures that the displayed taxiing line is the shortest.

In the example of FIG. 9, of the three routes plotted and possible to carry out the instruction, just one makes it possible to satisfy the two conditions defined previously. The first route joins the points and nodes 900, 901, 910, 911, 912, 913, the second route joins the points and nodes 900, 901, 910, 921, 920, 913 and the third route joins the points and nodes 900, 901, 910, 921, 933, 941, 940, 913.

The route satisfying the second condition expressed previously is the first route.

Thus, the inventive method makes it possible, when a number of taxiing lines satisfy an instruction originating from air traffic control, to select a taxiing line with optimum characteristics.

In these conditions, a display device can be used to plot the trajectory to be followed by the aircraft when an instruction is entered into a user interface. The correlation of the guidance chart and of the routing instruction makes it possible to select the arcs that form the taxiing line and makes it possible to optimize the most coherent path to be followed in the airport to arrive at the instruction destination.

On receipt of a taxiing instruction, the method identifies all the taxiing elements such as the taxiways for example along the route of the aircraft. The guidance chart makes it possible to calculate and display, through display means, a guidance trajectory supported by guidance lines all along the route.

The main benefit of the invention is the generation of a navigation and guidance chart based on navigation and guidance nodes and associated arcs. These nodes have the advantage of being easy to use when the aircraft passes close to them on the airport, to indicate navigation information or to make a plot of the trajectory to be followed on a display device.

1. A method of generating a connectivity chart for elements of an airport that makes use of:
data describing polygons, each polygon being referenced in a database of the aircraft, the data comprising at least one denomination, one type, one set of segments and one set of points, the polygons representing elements of an airport;
and that generates:
for any pair of polygons having a common boundary, at least one point, called node, situated on the boundary, the segment linking two consecutive nodes forming an axis with north;
wherein the method comprises:
the definition of a navigation arc, for each navigation node, the navigation arc being a segment linking two successive navigation nodes;
the determination of a heading, for each navigation node, called navigation heading, defining the angle between the direction of north and the navigation arc passing through the navigation node and oriented in the direction of passage of the aircraft;
the use of the position and the true heading of the aircraft supplied by the navigation system of said aircraft;
the use of the routing instructions originating from a ground-onboard communication device, the instructions comprising at least one destination and one route, the route comprising a series of elements of the airport navigation database management system, and;
the display of navigation airport information associated with a taxiing element from an onboard computer and viewing means, the navigation information being generated from the comparison of the true heading of the aircraft, the navigation heading and a position of a navigation node of an element of the instruction to be reached.

2. The method as claimed in claim 1, wherein it comprises the determination of a position of a node on a boundary, in such a way that the node is situated equidistant from each end of the boundary.

3. The method as claimed in one of claim 1 or 2, wherein it comprises the display of a runway proximity indication, inasmuch as the aircraft is located on the single possible path leading to that runway.

4. The method as claimed in claim 1, using:
data describing points of taxiing lines of an airport, the data originating from a database management system of the aircraft;
wherein it comprises the determination of at least one node, called guidance node, situated at the intersection of a boundary of two adjacent taxiing elements and a taxiing line.

5. The method as claimed in claim 4, wherein it comprises, for each guidance node, the definition of at least one guidance arc, the guidance arc being the shortest path to reach a next guidance node situated on a guidance line.

6. The method as claimed in claim 5, wherein it comprises, for each guidance node, the determination of a heading, called guidance heading, defining the angle between north and the segment linking points downstream and upstream of a guidance node situated on the taxiing line and oriented in the direction of passage of the aircraft.

7. The method as claimed in claim 6, that uses:
a routing instruction originating from a ground-onboard communication device, the instruction comprising at least one destination and one route, the route comprising a series of elements of the airport navigation database management system;
wherein it comprises the determination of a guidance trajectory, from an onboard computer, by determining the series of the segments linking points of a taxiing line and guidance nodes situated on elements of the routing instruction.

8. The method as claimed in claim 7, wherein it comprises the determination of the guidance trajectories for which the value of the radius of curvature is between a predefined minimum value and a predefined maximum value.

9. The method as claimed in claim 8, wherein it comprises the determination of the guidance trajectories for which the angle formed by two segments of three successive points is between 2 pi/3 and 4 pi/3.

10. The method as claimed in claim 9, wherein it comprises the determination of the shortest trajectory satisfying a routing instruction.

11. The method as claimed in claim 10, wherein it comprises the generation of the plot of the guidance trajectory on a map of an airport from an onboard computer and viewing means.

12. The method as claimed in claims 8 to 10, wherein it comprises the generation of an indication of deviation from the trajectory when the true position of the aircraft deviates from the guidance trajectory.

13. A device for generating a connectivity chart for elements of an airport for aircraft intended for assistance in airport taxiing that implements the method as claimed in any one of the preceding claims, the device comprising:
a user interface, the user being the crew, this interface comprising a display device;
an airport navigation database management system comprising navigation and guidance information;
an onboard computer;
geolocating means;
a locating device linked to the geolocating means;
a mapping device comprising a map of an airport, the latter being linked to the locating device, to the database management system and to the display device;
a ground-onboard communication device, able to deliver routing instructions, the instructions comprising at least one destination and one route, the route comprising a series of elements of the airport navigation database management system;
the display device comprising a plot of the trajectory to be followed by the aircraft overlaid on the map of the airport and the current position of the aircraft.

14. The device as claimed in claim 13, wherein it comprises means for manually inputting instructions originating from air traffic control.

15. The device as claimed in claim 13, wherein it comprises means for automatically inputting instructions originating from air traffic control.
